(19) United States
(12) Patent Application Publication
(10) Pub. No.: US 2003/0196497 A1
(43) Pub. Date: Oct. 23, 2003

(54) Torque measuring device

(76) Inventor: Ivo Geilenbrugge, Hilden (DE)

Correspondence Address: WILLIAM COLLARD, COLLARD & ROE, P.C., 1077 NORTHERN BOULEVARD, ROSLYN, NY, 11576, US

(21) Appl. No.: 10/417,502

(22) Filed: Apr. 17, 2003

(30) Foreign Application Priority Data
Apr. 18, 2002 (DE) 102 17 416.4

(51) Int. Cl. G01L 1/22

(52) U.S. Cl. 73/862.338

(57) ABSTRACT

A torque measuring device, in particular for use by means of commercially available tools, includes a measuring head with a connecting element provided for torque transmission. To permit the torque measuring instrument to be used universally, the connecting element is embedded in the measuring head and connected at one end to the component to be tightened and at the other end directly to a torque-producing tool. As a result, the torque measuring device can be used both with commercially available wrenches or other tools operated by electric motor or pneumatically. The torque measuring device is placed directly on the components to be tightened, while the tool is inserted into an existing tool holder. A particular advantage is that the torque measuring device is constructed so as to co-rotate, and therefore the possible use of driven tools is provided, on account of the possible rotation. A further advantage is that the achievement of a preset torque value can be displayed optically and, if appropriate, acoustically.

### BACKGROUND OF THE INVENTION

### CROSS REFERENCE TO RELATED APPLICATIONS

Applicant claims priority under 35 U.S.C. §119 of German Application No. 102 17 416.4 filed Apr. 18, 2002.

1. Field of the Invention

The present invention relates to a torque measuring device, in particular for use with commercially available tools.

2. The Prior Art

In order to fix a bolt or a threaded part with a specific torque, use is made, for example, of a torque wrench, which permits the tightening torque achieved to be read by using a torsion or bending bar. In most cases, this is a wrench attachment which, via an extended lever arm, permits the production of torque manually, in the simplest case the rotation of a torsion bar being used to determine the torque via a pointer and a read-off scale. For this purpose, calibration of the torsion bar with the scale is generally necessary. Such a torque wrench is used, for example, when tightening the wheel nuts of a vehicle. However, the measuring method described is very inaccurate and depends on the correct reading of the torque measured value, since the torque can be read only with extreme difficulty during tightening.

In addition, torque wrenches with an adjustable torque are known in which the force transmission is interrupted when the preset value is reached. Because interruption takes place very abruptly and without prewarning, injuries to the user repeatedly occur. Because driving is unexpectedly released and therefore there is no resistance, the lever arm whirls around or the operator loses his or her grip. For this reason, for example, the bolt is screwed tight and only retightened by means of a torque wrench, but in this case it is not possible to rule out the torque already being exceeded.

Furthermore, torque measuring instruments have been developed which, for example, permit electrical measurement. In order to measure the torques, use is made of the deformation of the torsion bar and the deformation is converted into a measured variable with the aid of a suitable measuring element. This may be, for example, a resistance, capacitance or inductance change. In the case of a resistance element, for example a strain gage, this can be used within a Wheatstone measuring bridge, so that a meaningful measured signal is generated with low resistance changes. This is preferably a differential measuring bridge, expediently an alternating current measuring bridge, which is tuned by the resistance change. The strain gages can in this case be active both in one and in both directions, so that an increase in the input sensitivity is possible. Alternatively, there is the possibility of using a capacitive or inductive measuring element.

Modern torque measuring instruments likewise use the torsional movement of a shaft on the basis of an applied torque, the torsional torque that occurs being converted into an electric output signal by suitable measuring elements. Furthermore, the rotational angle of the torsion bar can be measured at the same time, so that the rate of rise of the rotation is measured at the same time, and there is precise information about the quality of the joint.

Known torque measuring instruments, however, have the disadvantage that they can be used only for subsequent measurement after the torque has been applied. Otherwise, the handling of the torque measuring instrument together with the device that produces the torque is made substantially more difficult. Because the torque measuring instrument has to be coupled to the torque producing device and, because of the rotation that is produced, reading is made more difficult, or co-rotation of the torque measuring device is not possible. Furthermore, the familiar instruments are distinguished by a large-volume housing and very poor handling characteristics.

German laid-open specification DE 197 08 667 A1 discloses, for example, a method and a device for checking torques on screw connections and for checking motorized power wrenches and mechanical torque wrenches. In this case, in an electronic torque wrench, a sensor head is used that can be set horizontally by detent and fixed axially. This torque wrench is inserted with a force fit into a device and, in addition to checking screw connections, also permits checking of the aforementioned torque tools. However, the handling of the device is restricted to the envisaged intended use and can in no case be used for continuous monitoring during a screwing operation with, for example, a tool that produces torque.

DE 201 20 301 U1 also discloses a torque wrench, which has a shank with a handle at one end and a tool head at its other end. A display unit that is integrated in the handle and has a measuring system connected is used to display torque, the measuring system being connected hydraulically to the display. This torque wrench is suitable only for manual operation and likewise cannot be used for tools that produce torque.

### SUMMARY OF THE INVENTION

It is an object of the present invention to provide a torque measuring instrument which can be used universally, satisfies the current requirements on torque monitoring and permits reliable and simple measurement sensing while using commercially available tools for producing torque.

In accordance with the invention, these and other objects are achieved by providing a torque measuring device which includes a measuring head with a measuring head housing and a connecting element, accommodated in the measuring head, for torque transmission. The connecting element is connected at one end to the component to be tightened and at the other end to a tool that produces torque. At least one measuring element is provided on a contact surface which is located in the central shaft region of the connecting element. The device also includes measuring electronics, which are mounted in the measuring head housing and are connected to the measuring element.

The design of a torque measuring device according to the invention thus relates to a device which includes a measuring head and a connecting element. The torque measuring device can thus be used while using commercially available wrenches or other tools. The torque measuring device, together with the appropriate connecting elements, may be placed directly on the components to be tightened. A particular advantage results from a small compact design of the torque measuring device, so that even machine-operated torque-producing tools, for example electrically or pneumatically operated tools, can be used, since the torque measuring device can co-rotate without difficulty. As a result of a compact design, the torque measuring device can be used universally and can also be used at points which are difficult to access.

The measuring head has a measuring head housing which is firmly mounted on the connecting element so as to rotate with it. If appropriate, the measuring head housing can be fixed axially by securing rings, which permits co-rotation and also provides secure retention on the connecting element which is used for torque transmission. In a specific embodiment, the connecting element can be embedded coaxially in the measuring head housing and in this case is firmly connected to the measuring head or measuring head housing at one end so as to rotate with it, so that advantageously no distortion of the measuring head housing can occur when the connecting element is loaded torsionally. For this purpose, for the firmly mounted connection with the measuring head housing, the connecting element can have at least one axial groove, in which at least one spring belonging to the measuring head housing engages. A plurality of axial grooves and springs is advantageously used. These grooves and springs are arranged either diametrically opposite one another or distributed many times circumferentially. The connecting element includes a shaft provided on its end side with connecting elements, for example a square mounting or square end, which allows the use of all known tool inserts. The axial groove is preferably arranged in the region of the square socket, which has the largest outer diameter and thus, firstly, a sufficient cross section and, secondly, is subjected to only low torsional loading.

The connecting element has a surface-ground contact face for at least one measuring element between the connection elements, preferably in the region of the measuring head housing. The measuring head housing accommodates the measurement electronics. The measuring head housing is also equipped with a display and a plurality of function pushbuttons. In this way, the data to program or control the torque measuring device can be entered via the function pushbuttons with or without user guidance. Furthermore, the display can be used to display the torque measured value achieved or further data. In order to monitor and display the set torque measured value, a further embodiment of the invention provides for the measuring head to have optical and/or acoustic signal generators. Alternatively, there is the possibility for the measured value results to be transmitted via a cable-free transmitting device to a stationary functional unit, which performs an evaluation of the measured results and which likewise has optical and/or acoustic signal generators. In this embodiment, the function pushbuttons are optionally replaced by the radio device unit.

In a particular refinement of the invention, the measurement electronics may be used without batteries and the necessary supply voltage may be fed in via a transponder.

In one preferred embodiment, the measuring element includes at least one strain gage, which is adhesively bonded to the contact face and is connected via suitable contact elements to the measurement electronics mounted in the measuring head housing. Alternatively, the measuring element may include a plurality of strain gages, a piezo-electric element, a linear Hall sensor element, a ceramic strain element or a resilient magnetic element. The measuring elements indicated are all suitable to be fixed to the existing planar face of the connecting element, so that the mechanical torsion that occurs is converted into an electric signal which, for example, is fed to a known Wheatstone measuring bridge and permits an extremely accurate measurement after calibration of the torque measuring device has been carried out. For measured value evaluation, a microprocessor is preferably used. The microprocessor receives the signal obtained from the measuring element via a differential amplifier and an A/D converter. In this way, a comparative measurement with values entered via the function pushbuttons may be carried out. Furthermore, using existing storage elements and existing microprogramming, the microprocessor controls the display element and, if appropriate, transmits the data to a stationary functional unit for further evaluation and display of the data determined.

The torque measuring device according to the invention is provided for torque measurement, measured value evaluation and monitoring and transmission by means of an incorporated microcontroller, the torque measuring device being designed to co-rotate and being capable of being used both manually and on machine-operated tools. Limiting values may be present by means of the function pushbuttons or, if appropriate, an external monitoring unit, in order to predefine individual measured value ranges. In this way, the user may be informed in good time by an optical and/or acoustic signal about reaching the minimum value and/or exceeding the maximum value.

According to the invention, the torque measuring device can be used both for torque measurement and for angle measurement. In this case, there is the possibility, via the rotational angle measurement and torsion measurement, to display a characteristic curve of the screwed connection and therefore to obtain more detailed knowledge about the connection achieved and its quality.

Of particular advantage is that, because of the connecting element used, the torque measuring device can be used with all mechanical or power-operated tools, and continuous monitoring of the torque measured value is carried out and, when a set torque is reached, an acoustic and possibly optical signal is generated. A significant advantage is that, by using the most recent microchip technology, an extremely compact design is created. Because of the existing connectors of the connecting element, this compact design can be used with virtually all tools and does not entail any detrimental effects during the production of a screwed connection. The torque applied is monitored continuously in this case and, when the preset value is reached, which can possibly lie slightly below the maximum permissible value, an acoustic signal is transmitted to the operator, so that it is possible to switch off the tool in advance, and visual inspection of the achieved measured value results is subsequently possible by using the display. For the case in which an angle measurement is to be carried out at the same time, this signal can be picked up via a measured angle sensor and can be supplied to the microprocessor via an input amplifier with high/low filter and an A/D converter.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings,

FIG. 1 shows an exploded illustration of the torque measuring device according to an embodiment of the invention with all the individual parts,

FIG. 2 shows a number of views of the assembled torque measuring device according to FIG. 1, and

FIG. 3 shows a block diagram of the electronics contained in the torque measuring device.

### DETAILED DESCRIPTION OF PREFERRED EMBODIMENTS

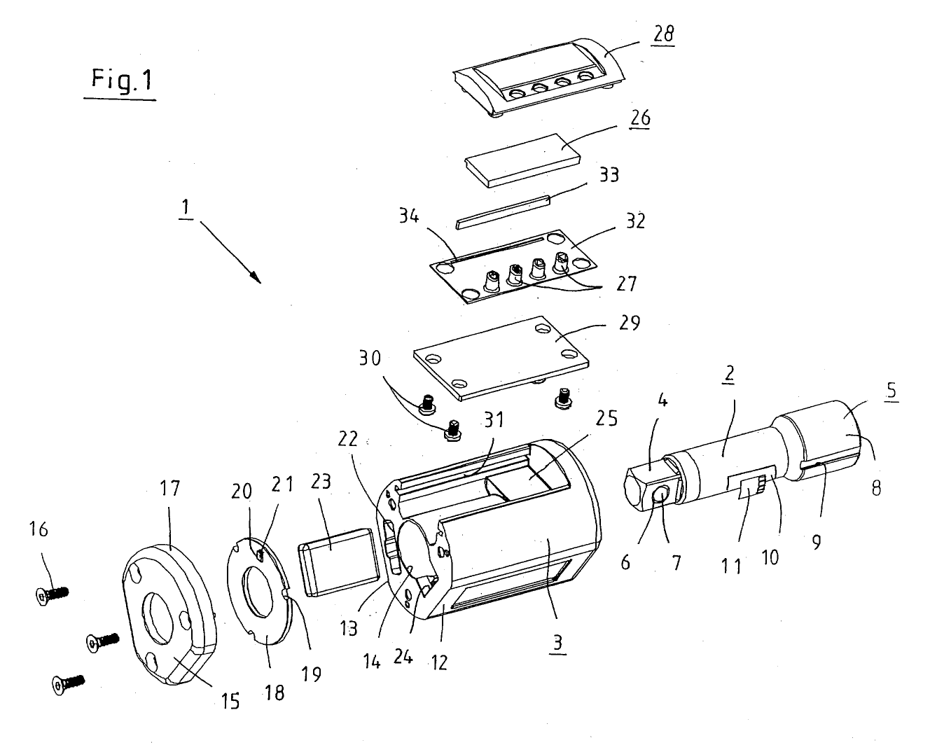

FIG. 1 shows an exploded illustration of all the individual parts of a torque measuring device 1, including a connecting element 2 provided for torque transmission and a measuring head housing 3, and also the further individual parts needed to measure the torque.

Connecting element 2 serves primarily to transmit the torque and is subjected to the torsional loading. Connecting element 2 includes a round pin with an integrally molded square 4 at one end and an integrally molded square socket 5 at the opposite end. Square 4 is designed to accommodate a commercially available bolt socket, for example a nut or the like and, for the purpose of retention and locking, has a locking ball 7 embedded in a hole 6. Square socket 5 is enlarged radially with respect to connecting element 2. In this way, an internal square recess is formed, into which a torque-producing tool, for example a device driven by electric motor or pneumatically and having a square can be inserted. Formed on the outer surface 8 in the axial direction is an axial groove 9, in which a corresponding spring belonging to measuring head housing 3 engages, so that measuring head housing 3 is firmly connected to connecting element 2 on one side so as to rotate with it. Measuring head housing 3 can further be secured on connecting element 2 by an axial securing ring, in order that the housing cannot slip off connecting element 2. Fixing measuring head housing 3 to connecting element 2 on one side ensures that, when torsional loading of connecting element 2 occurs, this loading is not transmitted to measuring head housing 3. In the central shaft region, connecting element 2 has a surface-ground or chamfered contact face 10, on which a measuring element 11 is fixed. Measuring element 11 may take the form, for example, of a strain element, a piezo-electric element, a linear Hall sensor element, a ceramic strain element or a resilient magnetic element. Measuring element 11 is, for example, adhesively bonded to contact face 10, so that torsional deformations of connecting element 2 which occur are transmitted to measuring element 11. The measuring elements 11 listed convert the torsional and compressive stresses which occur into a measured value which can be fed to further electronics, for example via a Wheatstone measuring bridge, so that evaluation of the torque achieved is possible.

Viewed in cross section, measuring head housing 3 is of approximately circular construction and is equipped with two planar faces 12, 13 machined in the circumferential face. However, these planar faces have no particular significance, and a circular measuring head housing 3 or any other desired cross section can likewise be selected. Following assembly, connecting element 2 is embedded coaxially in measuring head housing 3 in an aperture 14, in which there are formed the springs, not visible, which engage in axial groove 9 of connecting element 2. Following assembly, measuring head housing 3 is closed by a housing cover 15, housing cover 15 being fixed by means of screws 16. On its inner side 17, housing cover 15 has an axial recess, in which a disc-like plate 18 is embedded following assembly. In the region of screws 16, plate 18 is equipped with cutouts 19, so that screws 16 can engage in measuring head housing 3.

Furthermore, an integrated transmitter 21 is inserted into an existing cutout 20. Transmitter 21 is provided to transmit the measured data packet up to a stationary evaluation device. A flat angle measuring element 23 is inserted into a further rectangular recess 22 in the measuring head housing. In addition to the torsion measurement, angle measuring element 23 also determines the angle achieved by the torsional rotation, so that an angle measurement and torsion measurement can be carried out via the existing value electronics, and detailed knowledge about the connection achieved and its quality can be displayed via a characteristic curve that is determined.

Aperture 14 in measuring head housing 3 is to the greatest extent circular with a lateral rectangular recess 24, which is arranged so as to correspond to contact face 10 of connecting element 2 and creates sufficient free space for it to be possible to make electrical contact between measuring element 11 and the further measured value electronics arranged in measuring head housing 3.

In the front region of measuring head housing 3 is an axial depression 25, which is provided to accommodate a display 26 with function pushbuttons 27. Display 26 is accommodated in a housing part 28 having a baseplate 29, which can be connected via screws 30. In terms of its dimensions, baseplate 29 is designed to be somewhat larger than housing part 28, so that baseplate 29 can be inserted into an existing groove 31 in measuring head housing 3, while housing part 28 slides flush into the existing depression. Housing part 28 is preferably produced in a transparent design, in order that display 26 is visible from the outside and is protected. Display 26 is arranged between housing part 28 and an intermediate plate 32, which is used at the same time to hold function pushbuttons 27. The exact positioning of display 26 is ensured by a rubber strip 33, which is embedded in a groove 34 in intermediate plate 32. Thus, display 26 comes to lie on intermediate plate 32 between rubber strip 33 and function pushbuttons 27 and, on the side pointing outward, is covered by housing part 28 and screwed by means of baseplate 29 to form one unit. Underneath housing part 28 with baseplate 29 there remains sufficient free space to accommodate the necessary value electronics. The value electronics are connected to the actual measuring element 11 and possibly to angle measuring element 23.

In a preferred embodiment, the measured values determined may be transmitted directly, via a cable-free radio connection, to a stationary evaluation unit. Alternatively, the measured values determined by the measuring device may be displayed on the display and an acoustic or possibly optical display may signal when a preset torque has been reached. In this case, the presetting is carried out via existing function pushbuttons 27. As an alternative, the presetting may be performed via an external evaluation unit and the displaying and evaluating of the measured values may be achieved via the existing radio connection and via outputting the required optical or acoustic signals.

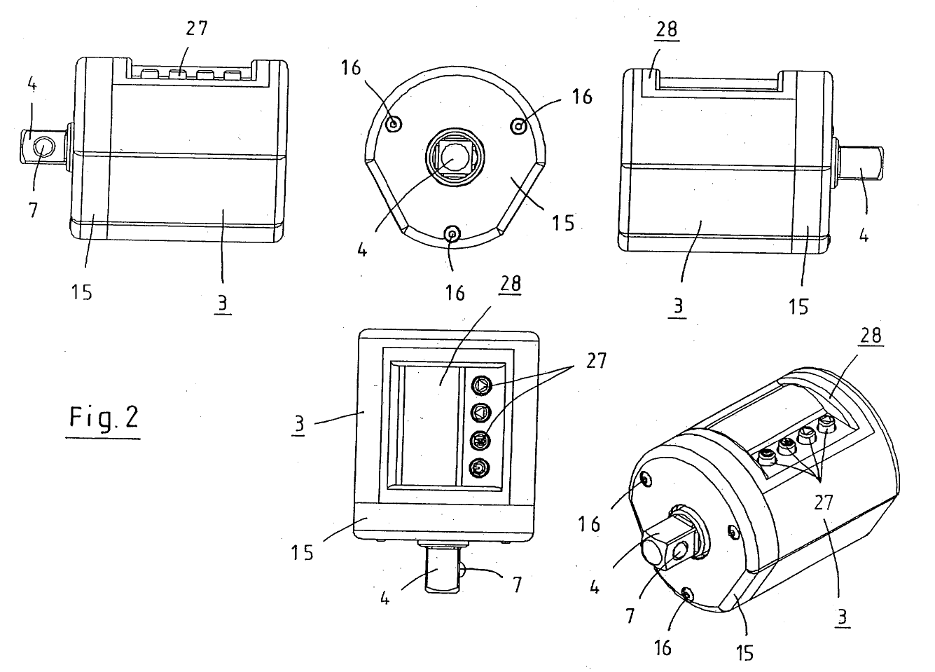

FIG. 2 shows torque measuring device 1 in a number of side views and in a perspective illustration following assembly. Measuring head housing 3 and housing cover 15 are screwed to each other via screws 16. Housing part 28 with display 26 and function pushbuttons 27 are accommodated in existing recess 25. A square 4 with a shaft for transmitting the torque projects out of housing cover 15 and permits a commercially available tool insert to be fitted. Formed at the opposite end of the shaft is a square socket, as can be seen in FIG. 1. Housing part 28 has a plurality of function pushbuttons 27, four being shown in the exemplary embodiment, which permits presetting of the torque measured value to be monitored and changing display 26.

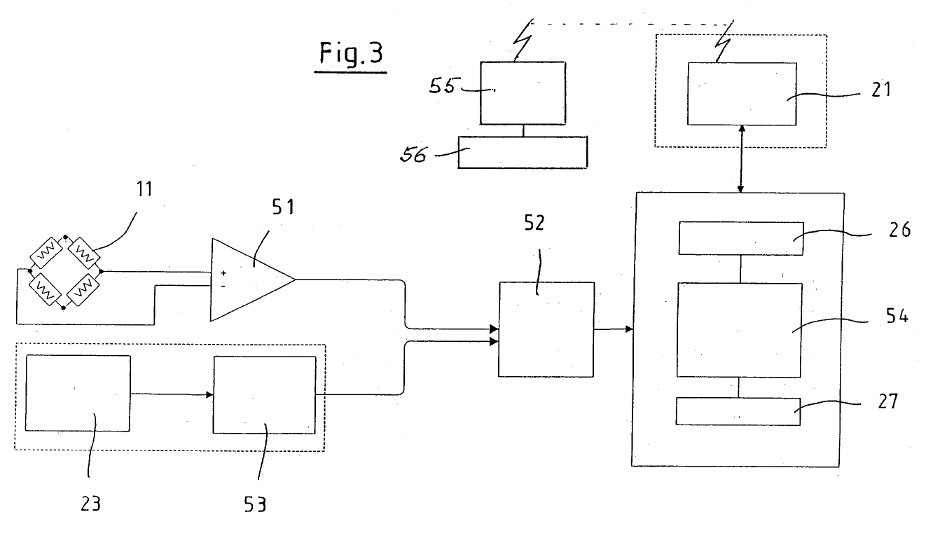

FIG. 3 shows the substantial components of the measured value electronics 50 in a block diagram. These electronics include a torque sensor, having at least one measuring element 11, and optionally an additional angle measuring element. The output signal from measuring element 11 is transmitted to an A/D converter 52 via a differential amplifier 51 and then fed to a microcontroller unit 54. Microcontroller unit 54 is used to evaluate the measured signals achieved, the unit having an appropriate memory for the program and the measured values achieved and being connected to function pushbuttons 27 in order that a presetting can be selected. Furthermore, microcontroller unit 54 controls display 26 or optionally transmits the data via a transmitting unit 21 and receiving unit 55 to a stationary evaluation unit 56. When angle measuring element 23 is used, its output signal is likewise supplied to the mirocontroller unit, via an amplifier 53 and A/D converter 52, for further evaluation. With the aid of the torque measured value and the angle measured value, it is thus possible for the angle-dependent torque achieved to be displayed graphically, for example on display 26, in an illustrative manner. The dashed components are used only optionally.

While only a few embodiments of the present invention have been shown and described, it is to be understood that many changes and modifications may be made thereunto without departing from the spirit and scope of the invention as defined in the appended claims.

What is claimed is:

1. A torque measuring device comprising:
(a) a measuring head having a measuring head housing;
(b) a connecting element having a central shaft region comprising a contact surface, said connecting element being accommodated in said measuring head for torque transmission and being adapted for connection at a first end to a component to be tightened and at a second end to a tool that produces torque;
(c) at least one measuring element on said contact surface; and
(d) measuring electronics mounted in said measuring head housing and connected to said measuring element.

2. The torque measuring device as claimed in claim 1, wherein said measuring head housing has a first end side firmly connected with said connecting element.

3. The torque measuring device as claimed in claim 1, wherein said measuring head housing is fixed axially by securing rings and said connecting element is coaxially embedded in said measuring head.

4. The torque measuring device as claimed in claim 1, wherein said connecting element has at least one axial groove and said measuring head housing comprises at least one spring engaging said at least one axial groove to connect said connecting element with said measuring head housing.

5. The torque measuring device as claimed in claim 4, wherein said connecting element comprises a shaft having a first end provided with a connector for a tool insert.

6. The torque measuring device as claimed in claim 5 wherein said connector is selected from the group consisting of a square socket and a square.

7. The torque measuring device as claimed in claim 5, wherein said connector comprises a square socket and said axial groove is arranged near the square socket.

8. The torque measuring device as claimed in claim 1, wherein said contact surface is surface-ground or chamfered.

9. The torque measuring device as claimed in claim 1, wherein said measuring head housing is equipped with a display and a plurality of function pushbuttons.

10. The torque measuring device as claimed in claim 1, wherein said measuring head has optical and/or acoustic signal generators or a cable-free transmitting device adapted to transmit measured results to a stationary evaluation unit having optical and/or acoustic generators and performing an evaluation of the measured results.

11. The torque measuring device as claimed in claim 1, wherein said measuring element comprises at least one strain gauge, adhesively bonded to said contact surface and is connected via contact elements to said measuring electronics.

12. The torque measuring device as claimed in claim 10, wherein the measured results are selected from the group consisting of torque measurements and angle measurements.

13. The torque measuring device as claimed in claim 1, wherein said measuring element is selected from the group consisting of one or more strain gauges, a piezo-electric element, a linear Hall sensor element, a ceramic strain element and a resilient magnetic element.

14. The torque measuring device as claimed in claim 1, further comprising a microcontroller for carrying out torque measurement, measured value evaluation, measured value monitoring and signal transmission.

15. The torque measuring device as claimed in claim 9, wherein limiting values are preset via the function pushbuttons or an external evaluation unit, and the measuring device provides an optical and/or acoustic signal to alert a user when a minimum value is reached and/or a maximum value is exceeded.

16. The torque measuring device as claimed in claim 1, wherein said measuring device is rotatable and adapted for use on both manually operated and machine-operated tools.
